(19) United States
(12) Patent Application Publication
(10) Pub. No.: US 2026/0332958 A1
(43) Pub. Date: Oct. 22, 2026

(54) DRIVER UNIT

(71) Applicant: YAMAHA CORPORATION, Hamamatsu-shi (JP)

(72) Inventor: Ryo HADANO, Hamamatsu-shi (JP)

(21) Appl. No.: 19/711,147

(22) Filed: Jun. 17, 2026

Related U.S. Application Data
(63) Continuation of application No. PCT/JP2025/006141, filed on Feb. 21, 2025.

(30) Foreign Application Priority Data
Mar. 19, 2024 (JP) 2024-044043

(51) Int. Cl. H04R 9/02; H04R 7/12

(52) U.S. Cl. CPC H04R 9/02; H04R 7/12

(57) ABSTRACT

A driver unit includes: a diaphragm; a driver unit main body having a vent hole formed on a rear side of the diaphragm; the ventilation member, which covers the vent hole from an outside of the driver unit main body; and a reinforcing member that reinforces the ventilation member. The ventilation member has an annular attachment portion attached to a peripheral region of an outer surface of the driver unit main body in which the vent hole opens. The reinforcing member has a plurality of strip portions which, when viewed in a direction in which the vent hole and the ventilation member overlap, extend from a center of the ventilation member to the attachment portion in mutually different directions.

### CROSS-REFERENCE TO RELATED APPLICATIONS

This application claims the benefit of Japanese Patent Application No. 2024-044043, filed Mar. 19, 2024, which is hereby incorporated by reference herein in its entirety.

### BACKGROUND

### 1. Technical Field

Various embodiments of the present invention relate to a driver unit.

### 2. Description of Related Art

U.S. Pat. No. 11,082,768 discloses a driver unit for a headphone. The driver unit of U.S. Pat. No. 11,082,768 includes a ventilation member (airflow resistor) that covers a vent hole formed on a rear side of a diaphragm. The ventilation member is provided for adjusting a frequency characteristic of the diaphragm.

### SUMMARY

In a driver unit having a ventilation member, it is desired to suppress total harmonic distortion (hereinafter also referred to as “THD”) caused by the ventilation member.

Various embodiments of the present invention have been made in view of the above circumstances, and the various embodiments of the present invention provide a driver unit capable of suppressing total harmonic distortion caused by a ventilation member.

In some embodiments of the present invention, there is provided a driver unit comprising: a diaphragm; a driver unit main body having a vent hole formed on a rear side of the diaphragm; a ventilation member that covers the vent hole from an outside of the driver unit main body; and a reinforcing member that reinforces the ventilation member. The ventilation member has an annular attachment portion attached to a peripheral region of an outer surface of the driver unit main body in which the vent hole opens. The reinforcing member has, when viewed in a direction in which the vent hole and the ventilation member overlap, a plurality of strip portions extending from a center of the ventilation member to the attachment portion in mutually different directions.

In some embodiments of the present invention, there is provided a driver unit comprising: a diaphragm; a driver unit main body having a vent hole formed on a rear side of the diaphragm; a ventilation member that covers the vent hole from an outside of the driver unit main body; and a reinforcing member that reinforces the ventilation member. The ventilation member has an annular attachment portion attached to a peripheral region of an outer surface of the driver unit main body in which the vent hole opens. The reinforcing member suppresses vibration of the ventilation member.

### BRIEF DESCRIPTION OF THE DRAWINGS

FIG. 1 is a sectional view showing a driver unit according to an embodiment of the present invention.

FIG. 2 is an exploded perspective view showing the driver unit of FIG. 1.

FIG. 3 is a plan view showing a ventilation member to which a reinforcing member and a fixing member are attached in the driver unit of FIGS. 1 and 2.

FIG. 4 is a sectional view taken along line IV-IV in FIG. 3.

FIG. 5 is a graph showing frequency characteristics of driver units of an embodiment and a comparative example.

FIG. 6 is a plan view of a modified example of the ventilation member to which the reinforcing member and the fixing member are attached, as viewed from the facing surface side of the ventilation member.

FIG. 7 is a plan view of the ventilation member of FIG. 6 as viewed from an opposite surface side of the ventilation member.

### DETAILED DESCRIPTION OF EMBODIMENTS

According to various embodiments of the present invention, in a driver unit, total harmonic distortion caused by a ventilation member can be suppressed.

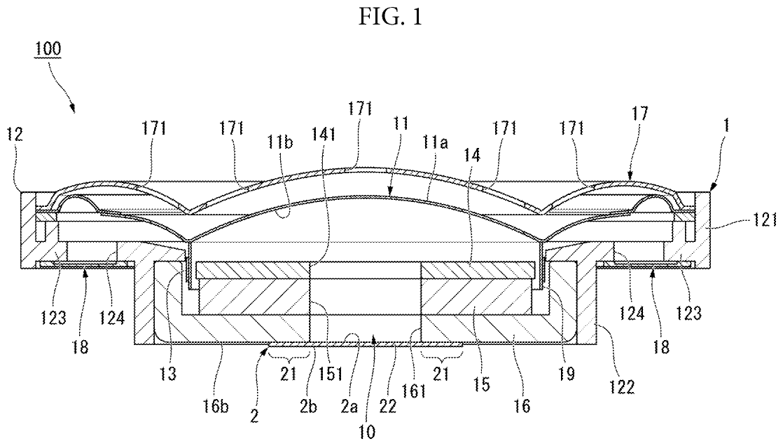

Hereinafter, various embodiments of the present invention will be described with reference to FIGS. 1 to 5.

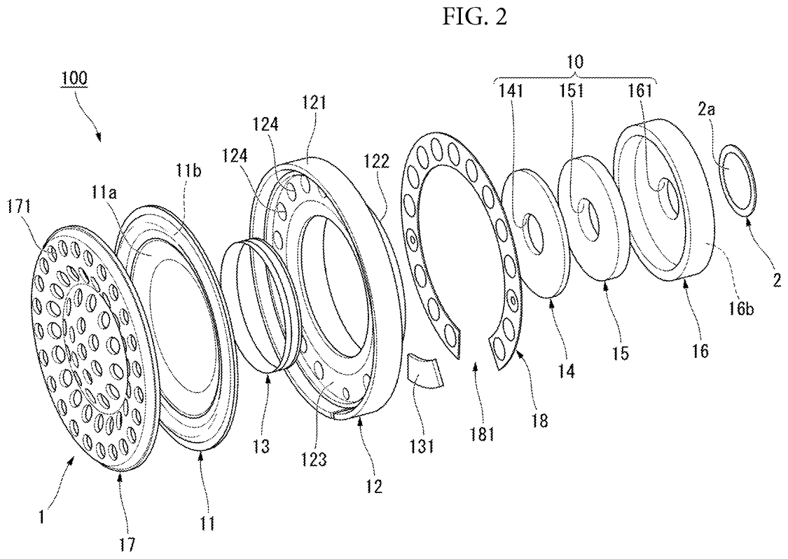

As shown in FIGS. 1 to 4, a driver unit 100 according to various embodiments of the present invention includes a driver unit main body 1, a ventilation member 2, a reinforcing member 3, and a fixing member 4. The reinforcing member 3 and the fixing member 4 are provided on the ventilation member 2, and are therefore not shown in FIGS. 1 and 2.

As shown in FIG. 1, the driver unit main body 1 includes a diaphragm 11 and a vent hole 10 formed on a rear surface 11b side of the diaphragm 11. In the driver unit main body 1, sound is generated by vibration of the diaphragm 11 in response to an electric signal input from the outside.

As shown in FIGS. 1 and 2, the driver unit main body 1 of various embodiments of the present invention includes the diaphragm 11, a frame 12, a voice coil 13, a pole piece 14, a magnet 15, a pot yoke 16, and a protector 17.

The frame 12 holds the diaphragm 11, the voice coil 13, the pole piece 14, the magnet 15, the pot yoke 16, and the protector 17 at respective appropriate positions. In some embodiments, as shown, for example, in FIGS. 1 and 2, the frame 12 is formed to be generally tubular. Specifically, the frame 12 includes a tubular large-diameter portion 121, a tubular small-diameter portion 122, and a flange portion 123. The large-diameter portion 121 and the small-diameter portion 122 are arranged adjacent to each other in a direction along their axis (hereinafter referred to as an axial direction). A diameter of the large-diameter portion 121 is larger than that of the small-diameter portion 122. The flange portion 123 is formed in a ring shape that projects radially outward from an end portion of the small-diameter portion 122 located on the large-diameter portion 121 side in the axial direction and reaches the large-diameter portion 121. A plurality of through holes 124 penetrating in the axial direction are formed in the flange portion 123. The plurality of through holes 124 are arranged at intervals in a circumferential direction of the flange portion 123.

A frame mesh 18 is disposed so as to overlap the flange portion 123 of the frame 12 from an outside of the frame 12. The frame mesh 18 is formed in a ring shape corresponding to the flange portion 123. Thus, the frame mesh 18 covers the plurality of through holes 124 of the flange portion 123 from the outside of the frame 12. The frame mesh 18 is made of a mesh material, a plain-woven fabric, or other textile, and does not prevent air from entering and leaving an inside of the frame 12 through the plurality of through holes 124 of the flange portion 123.

The frame mesh 18 shown in FIG. 2 has a cutout portion 181 in a part of its circumferential direction. A connection terminal 131 electrically connected to the voice coil 13 is disposed in the cutout portion 181 of the frame mesh 18.

The diaphragm 11 is attached to the frame 12 so as to divide an internal space of the tubular frame 12 in the axial direction. Specifically, the diaphragm 11 is attached to the large-diameter portion 121 of the frame 12. In the following description, a surface of the diaphragm 11 facing toward the small-diameter portion 122 of the frame 12 is referred to as a rear surface 11b, and a surface of the diaphragm 11 on an opposite side to the rear surface 11b is referred to as a front surface 11a.

A space inside the small-diameter portion 122 of the frame 12, and the flange portion 123 and the plurality of through holes 124 formed therein, are opposed to the rear surface 11b side of the diaphragm 11.

The protector 17 is attached to the frame 12 so as to be disposed on the front surface 11a side of the diaphragm 11. The protector 17 protects the front surface 11a side of the diaphragm 11 so as not to interfere with vibration of the diaphragm 11. A plurality of openings 171 are formed in the protector 17. Accordingly, the protector 17 does not prevent air from entering and leaving a space between the protector 17 and the front surface 11a of the diaphragm 11 through the plurality of openings 171 of the protector 17.

The voice coil 13 is attached to a tubular bobbin 19 provided on the rear surface 11b of the diaphragm 11. The voice coil 13 is disposed inside the small-diameter portion 122 of the frame 12.

The pole piece 14, the magnet 15, and the pot yoke 16 are provided on the rear surface 11b side of the diaphragm 11, and constitute a magnetic circuit forming portion that forms magnetic fields inside and outside the voice coil 13. The pole piece 14, the magnet 15, and the pot yoke 16 are all disposed inside the small-diameter portion 122 of the frame 12. The pot yoke 16 is disposed at an opening on the small-diameter portion 122 side of the frame 12. Therefore, a rear surface 16b of the pot yoke 16 facing the same side as the rear surface 11b of the diaphragm 11 constitutes part of an outer surface of the driver unit main body 1 together with an outer surface of the frame 12.

Through holes 141, 151, and 161 for opening a space on the rear surface 11b side of the diaphragm 11 to an outside of the driver unit main body 1 are respectively formed in the pole piece 14, the magnet 15, and the pot yoke 16. The respective through holes 141, 151, and 161 of the pole piece 14, the magnet 15, and the pot yoke 16 constitute the vent hole 10 of the driver unit main body 1 formed on the rear surface 11b side of the diaphragm 11.

In the driver unit main body 1 configured as described above, the diaphragm 11 vibrates in response to an electric signal input to the voice coil 13 from the outside. Thus, sound is emitted from the front surface 11a side of the diaphragm 11 to the outside of the driver unit main body 1 through the plurality of openings 171 of the protector 17. The vibration of the diaphragm 11 also propagates from the rear surface 11b of the diaphragm 11 to the outside of the driver unit main body 1 through the respective through holes 141, 151, and 161 of the pole piece 14, the magnet 15, and the pot yoke 16 (e.g., the vent hole 10 of the driver unit main body 1), and the plurality of through holes 124 of the flange portion 123 of the frame 12.

The ventilation member 2 covers the vent hole 10 of the driver unit main body 1 from the outside of the driver unit main body 1. The ventilation member 2 is made of a mesh material, a plain-woven fabric, or other textile, and does not prevent air from entering and leaving an inside of the frame 12 through the vent hole 10.

As shown in FIGS. 1, 3, and 4, the ventilation member 2 has an annular attachment portion 21 attached to a peripheral region of an outer surface of the driver unit main body 1 in which the vent hole 10 opens. The attachment portion 21 is a portion of the ventilation member 2 that overlaps a fixing member 4 described later. The ventilation member 2 also has a covering portion 22 that is located inside the attachment portion 21 and covers the vent hole 10 of the driver unit main body 1.

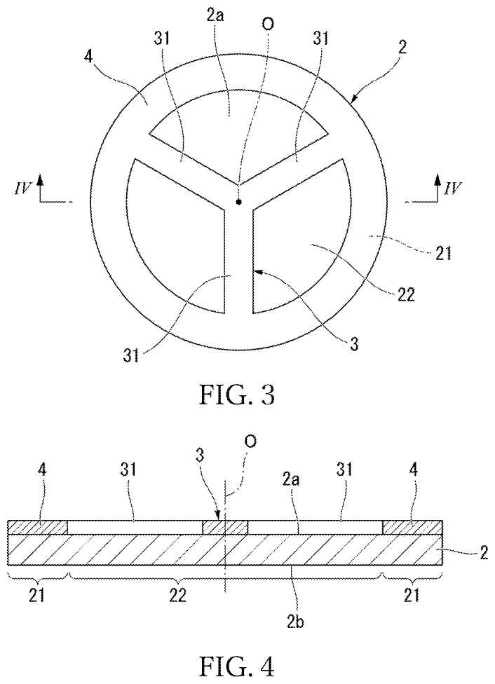

The ventilation member 2 illustrated in FIG. 3 is formed in a circular shape in plan view as viewed in a thickness direction thereof, but is not limited thereto, and may be, for example, a rectangular shape. However, it is more preferable that a plan-view shape of the ventilation member 2 be the same shape as a plan-view shape of the vent hole 10 of the driver unit main body 1.

As shown in FIGS. 3 and 4, the reinforcing member 3 reinforces the ventilation member 2 described above. The reinforcing member 3 has a function of suppressing vibration of the ventilation member 2. Specifically, the reinforcing member 3 suppresses vibration of the ventilation member 2 to control vibration characteristics of the ventilation member 2. The reinforcing member 3 is made of a material less stretchable than the ventilation member 2, and examples thereof include polyethylene terephthalate (PET).

As shown in FIG. 3, the reinforcing member 3 has, when viewed in a direction (the thickness direction of the ventilation member 2) in which the vent hole 10 of the driver unit main body 1 and the ventilation member 2 overlap, a plurality of strip portions 31 extending from a center O of the ventilation member 2 to the attachment portion 21 in mutually different directions. The plurality of strip portions 31 respectively overlap the covering portion 22 of the ventilation member 2. In some embodiments, as shown, for example, in FIG. 3, the plurality of strip portions 31 are arranged at equal intervals in a circumferential direction of the attachment portion 21 of the ventilation member 2 about the center O of the ventilation member 2. Widths (thicknesses) of the plurality of strip portions 31 as viewed in the thickness direction of the ventilation member 2 are equal to one another. It is more preferable that the width of each strip portion 31 be small. The widths of the strip portions 31 may be different among the plurality of strip portions 31. The number of strip portions 31 in FIG. 3 is three, but may be two or four or more, for example. In some embodiments, as shown, for example, in FIGS. 3 and 4, the reinforcing member 3 described above is provided on a facing surface 2a of the ventilation member 2 that faces toward the driver unit main body 1.

The fixing member 4 is provided on the facing surface 2a of the ventilation member 2. The fixing member 4 has a function of fixing the attachment portion 21 of the ventilation member 2 to the peripheral region described above. That is, the fixing member 4 is formed in an annular shape corresponding to the attachment portion 21. The fixing member 4 may be, for example, an adhesive. The fixing member 4 may also be, for example, a double-sided adhesive tape having a PET base material. When the fixing member 4 is a double-sided adhesive tape, the attachment portion 21 can be easily attached to the peripheral region by preliminarily making the fixing member 4 have the same shape as the attachment portion 21.

In some embodiments, the reinforcing member 3 described above is formed integrally with the fixing member 4. Therefore, in some embodiments, the reinforcing member 3 is made of the same material as the fixing member 4.

In the driver unit 100 of some embodiments, as shown, for example, in FIGS. 3 and 4, in a state where the ventilation member 2 is fixed to the outer surface of the driver unit main body 1 (the rear surface 16b of the pot yoke 16) by the fixing member 4, there is extremely little or substantially no portion of the attachment portion 21 of the ventilation member 2 that is not fixed by the fixing member 4 on a radially inner side of the annular fixing member 4.

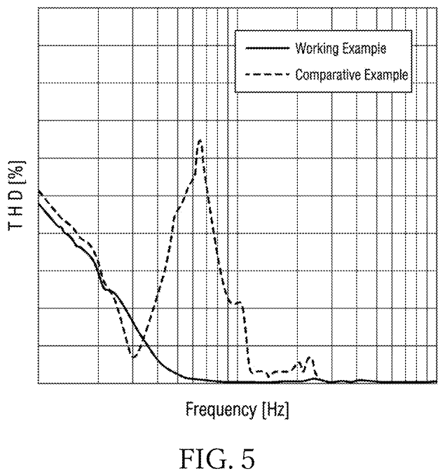

Next, with reference to FIG. 5, an explanation will be given of how, in the driver unit 100 of various embodiments of the present invention, THD caused by the ventilation member 2 can be suppressed. The graph of FIG. 5 shows frequency characteristics of driver units of an embodiment and a comparative example. The driver unit of the embodiment is the driver unit 100 according to an embodiment of the present invention. The driver unit of the comparative example has a configuration in which the reinforcing member 3 is not provided on the ventilation member 2 in the driver unit 100 of the present embodiment.

In the driver unit of the comparative example, in a low frequency band, THD tends to decrease as the frequency increases, but a peak at which THD increases appears in an intermediate frequency band. This THD peak is caused by the ventilation member 2. Specific factors by which the ventilation member 2 increases THD include sound generated from the ventilation member 2 that vibrates greatly and sound generated when the ventilation member 2 vibrates greatly and strikes the driver unit main body 1 (the pot yoke 16).

In contrast, in the driver unit 100 according to an embodiment of the present invention, THD decreases continuously as the frequency increases from the low frequency band to the intermediate frequency band. That is, a THD peak does not appear in the intermediate frequency band. From the above, it has become clear that THD caused by the ventilation member 2 can be suppressed by the reinforcing member 3.

As described above, in the driver unit 100 of various embodiments of the present invention, the ventilation member 2 attached to the driver unit main body 1 is less likely to vibrate due to the reinforcing member 3. Specifically, the plurality of strip portions 31 of the reinforcing member 3 increase rigidity of the ventilation member 2, thereby making the ventilation member 2 less likely to vibrate. Thus, even if vibration of the diaphragm 11 is transmitted to the ventilation member 2 through the vent hole 10 of the driver unit main body 1, it is possible to effectively suppress a situation where the ventilation member 2 vibrates greatly due to the vibration of the diaphragm 11 and sound is generated from the ventilation member 2. Therefore, THD caused by the ventilation member 2 can be suppressed.

Further, in the driver unit 100 in some embodiments of the present invention, the reinforcing member 3 is formed integrally with the fixing member 4 that fixes the attachment portion 21 of the ventilation member 2 to the outer surface of the driver unit main body 1. Therefore, THD can be suppressed without increasing the number of components of the driver unit 100.

Further, in the driver unit 100 in some embodiments of the present invention, a ventilation region of the ventilation member 2 through which air passes is divided into a plurality of regions by the plurality of strip portions 31. By arranging the plurality of strip portions 31 at equal intervals in the circumferential direction of the attachment portion 21, sizes and shapes of the plurality of ventilation regions can be made equal to one another. Accordingly, vibration characteristics of the plurality of ventilation regions become equivalent, and thus THD can be more effectively suppressed.

Further, in the driver unit 100 of in some embodiments of the present invention, in a state where the ventilation member 2 is fixed to the outer surface of the driver unit main body 1 by the fixing member 4, there is extremely little or substantially no portion of the attachment portion 21 of the ventilation member 2 that is not fixed by the fixing member 4 on the radially inner side of the annular fixing member 4. Therefore, when the ventilation member 2 vibrates relative to the driver unit main body 1, it is possible to suppress or prevent sound from being generated when a portion of the attachment portion 21 of the ventilation member 2 that is not fixed, together with a portion that is fixed by the fixing member 4, contacts the outer surface of the driver unit main body 1. As a result, THD can be effectively suppressed.

Although various embodiments of the present invention have been described in detail above, the present invention is not limited to the above various embodiments, and various modifications can be made without departing from the spirit of the present invention.

In the driver unit 100 of some embodiments, for example, the plurality of through holes 124 formed in the flange portion 123 of the frame 12 may constitute the vent hole of the driver unit main body 1 formed on the rear surface 11b of the diaphragm 11. The frame mesh 18 may also function as the ventilation member in some embodiments of the present invention. Therefore, the frame mesh 18 may be provided with the reinforcing member 3 and the fixing member 4 similar to those in the embodiments discussed above. In this way, THD caused by the frame mesh 18 can be suppressed.

In the driver unit 100 of the some embodiments, it is sufficient that one of the respective through holes 141, 151, and 161 of the pole piece 14, the magnet 15, and the pot yoke 16, which function as the vent hole of the driver unit main body 1, and the plurality of through holes 124 formed in the flange portion 123 of the frame 12, be formed. By one of these through holes, a part of the space on the rear surface 11b side of the diaphragm 11 can be opened to the outside of the driver unit main body 1.

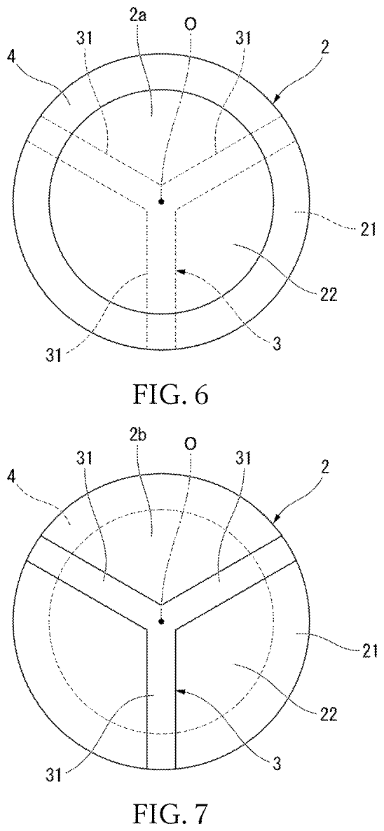

In some embodiments of the present invention, the plurality of strip portions 31 of the reinforcing member 3 may not be formed integrally with the fixing member 4, as shown in FIGS. 6 and 7, for example. The reinforcing member 3 may also be provided on an opposite surface 2b of the ventilation member 2 that faces in a direction opposite to the facing surface 2a, as shown in FIGS. 6 and 7. In the configuration examples of FIGS. 6 and 7, the plurality of strip portions 31 provided on the opposite surface 2b of the ventilation member 2 extend from the center O of the ventilation member 2 to the attachment portion 21 of the ventilation member 2 in mutually different directions and overlap the fixing member 4 in the thickness direction of the ventilation member 2. Thus, even when the reinforcing member 3 and the fixing member 4 are separate components, the ventilation member 2 can be attached to the driver unit 100 without gaps.

In some embodiments of the present invention, the plurality of strip portions 31 of the reinforcing member 3 may be arranged at unequal intervals in the circumferential direction of the attachment portion 21 of the ventilation member 2. Even with such a configuration, the rigidity of the ventilation member 2 is increased by the reinforcing member 3, and therefore THD caused by the ventilation member 2 can be suppressed.

What is claimed is:

1. A driver unit, comprising:
a diaphragm;
a driver unit main body having a vent hole formed on a rear side of the diaphragm;
a ventilation member that covers the vent hole from an outside of the driver unit main body; and
a reinforcing member that reinforces the ventilation member,
wherein the ventilation member has an annular attachment portion attached to a peripheral region of an outer surface of the driver unit main body in which the vent hole opens, and
wherein the reinforcing member has, when viewed in a direction in which the vent hole and the ventilation member overlap, a plurality of strip portions extending from a center of the ventilation member to the annular attachment portion in mutually different directions.

2. The driver unit according to claim 1, further comprising:
a fixing member provided on a facing surface of the ventilation member that faces toward the driver unit main body, the fixing member fixing the annular attachment portion to the peripheral region,
wherein the reinforcing member is provided on the facing surface of the ventilation member and is formed integrally with the fixing member.

3. The driver unit according to claim 1, wherein the plurality of strip portions are arranged at equal intervals in a circumferential direction of the annular attachment portion about the center of the ventilation member.

4. The driver unit according to claim 2, wherein the plurality of strip portions are arranged at equal intervals in a circumferential direction of the annular attachment portion about the center of the ventilation member.

5. A driver unit comprising:
a diaphragm;
a driver unit main body having a vent hole formed on a rear side of the diaphragm;
a ventilation member that covers the vent hole from an outside of the driver unit main body; and
a reinforcing member that reinforces the ventilation member,
wherein the ventilation member has an annular attachment portion attached to a peripheral region of an outer surface of the driver unit main body in which the vent hole opens, and
wherein the reinforcing member suppresses vibration of the ventilation member.
